(19) United States
(12) Patent Application Publication
(10) Pub. No.: US 2009/0244177 A1
(43) Pub. Date: Oct. 1, 2009

(54) IMAGE RECORDING DEVICE AND IMAGE RECORDING METHOD

(76) Inventor: Setsuji TATSUMI, Kanagawa (JP)

Correspondence Address: BIRCH STEWART KOLASCH & BIRCH, PO BOX 747, FALLS CHURCH, VA, 22040-0747, US

(21) Appl. No.: 12/407,928

(22) Filed: Mar. 20, 2009

(30) Foreign Application Priority Data
Mar. 31, 2008 (JP) 2008-091468

(51) Int. Cl. B41J 23/00

(52) U.S. Cl. 347/37

(57) ABSTRACT

An image recording device comprises: a transport unit for transporting a recording medium in an auxiliary scan direction; a recording head for drawing an image on the recording medium; a scanning unit for causing the recording head to scan the recording medium in a main scan direction that is normal to the auxiliary scan direction; and a control unit for controlling the transport unit, the recording head and the scanning unit to form an image in a same area of the recording medium extending in the main scan direction by shingling.

### BACKGROUND OF THE INVENTION

The invention relates to an ink jet recording type image recording device and image recording method and, in particular, to an image recording device and an image recording method that reduces occurrence of inconsistent density attributable to inconsistent ink discharge characteristics.

Among image recording devices for recording an image on a recording medium is an ink jet recording device whereby ink drops are discharged from nozzles according to an image signal and allowed to land onto the recording medium, thereby recording an image.

The ink jet recording devices use a drawing method called a serial method or a shuttle method, among others.

According to this method, an ink jet head (recording head) provided with a plurality of nozzles is reciprocated using a carriage in a direction (a main scan direction) normal to an auxiliary scan direction in which a recording medium is transported as ink drops are discharged from the nozzles according to image recording signals to record a part of an image of interest in the recording medium width direction, thereafter repeating the procedure in which the ink jet head is reciprocated while the recording medium is transported in a relative movement in the main scan direction to record parts of the image until a complete image as desired is recorded on the recording medium.

The serial method uses an ink jet head in which rows of nozzles are arranged in a staggered fashion to increase the resolution of a recorded image and the image recording speed. However, ink jet heads including one of a type having nozzles arranged in a staggered fashion as described above have a problem of inconsistent ink discharge characteristics among rows of nozzles. JP 11-216856 A proposes an ink jet head providing a solution to such a problem of inconsistent ink discharge characteristics.

JP 11-216856 A describes a recording device using a recording head of an ink jet recording type. The recording device described in JP 11-216856 A comprises main scan means for causing the recording heads to scan a recording medium in a relative movement in a main scan direction; auxiliary scan means for causing the recording medium to move in relation to the recording heads in an auxiliary scan direction that is different from the main scan direction; and control means whereby the recording heads comprising rows of recording elements, arranged in a scattered fashion, is caused to perform main scan on a same line on the recording medium a plurality of times in a relative movement against an auxiliary scan performed at least once in the meantime to accomplish recording on the same line. The control means uses different rows of recording elements to accomplish recording on the same line.

Thus, in a multi-pass printing using recording heads arranged in a staggered fashion, the same line is formed using nozzles of different rows to scatter the directivity of dots that miss the correct landing positions on the same line and improve on inconsistent density due to inconsistency between rows of nozzles.

While the device described in JP 11-216856 A is effective in improving on the inconsistent characteristics among rows of nozzles, an ink jet head having a different structure is proposed in the prior art (see JP 2005-313622 A).

As illustrated in FIG. 7, a recording head 100 described in JP 2005-313622 A comprises an ink supply system including common flow channels 160A, 160B provided as main flow channels, branches 162, main supply inlets 164, and valves.

The common flow channels 160A and 160B are provided in two upper and lower rows along the main scan direction on both sides of ink chamber units 153 disposed in a staggered, matrix pattern. At the ends 166 of the common flow channels 160A, 160B on the right and left-hand sides thereof are formed the main supply inlets 164 to which supply ducts 168 are connected to supply ink. In the recording head 100, the supply ducts 168 at lower right and upper left in FIG. 7 meet to form a main flow channel 169.

The branches 162 are provided in a plurality of rows along the main scan direction in the same manner as the pressure chambers 152 are arranged so as to communicate with the upper and lower common flow channels 160A, 160B. Thus, the branches 162 are disposed so as to bridge the two upper and lower rows of common flow channels 160A, 160B. The branches 162 communicate respectively with the supply inlets 154 of the pressure chambers 152.

The ink supplied through the supply ducts 168 in the ink supply system thus configured is further fed through the common flow channels 160A, 160B and the branches 162 to reach the respective pressure chambers 152.

### SUMMARY OF THE INVENTION

Since the recording head 100 described in JP 2005-313622 A has a flow structure as illustrated in FIG. 7, the problem it presents lies not in inconsistent characteristics among rows of nozzles as described in JP 11-216856 A but lies in difference in nozzle characteristics depending upon the position in a branch 162 to which a given nozzle (pressure chamber) is connected. That is, the discharge characteristics of a given nozzle vary with the position of that particular nozzle in the branch. Because the problem does not lie in inconsistent characteristics among rows of nozzles, JP 11-216856 A fails to solve the problem of inconsistent nozzle characteristics as described in JP 2005-313622 A.

In the recording head 100 illustrated in FIG. 7, the nozzle A and the nozzle F located in the same branch 162A each have other nozzles on one side thereof only. In other words, these nozzles each have other nozzles on only one side thereof that give them cross-talk effects. By contrast, the nozzles C and D each have other nozzles on both sides thereof in the same branch 162A and receive cross-talk effects from the nozzles on both sides. Therefore, the nozzles A to F receive cross-talk effects in such an amount or with such a probability as nozzles A and F<nozzles B and E<nozzles C and D.

Specifically, the recording head 100 described in JP 2005-313622 A has nozzle characteristics as illustrated in FIGS. 8 to 10.

FIG. 8 illustrates how the rate of change of the discharge amount is different when ink is discharged simultaneously from two of the nozzles A to F in the same branch 162A of the recording head 100 described in JP 2005-313622 A. Thus, when nozzles located in proximity are operated simultaneously, the cross-talk changes the discharge amount and the discharge speed. In most cases, the discharge amount and speed decrease, and the effects increase as the distance between nozzles decreases.

However, discharge from nozzles in a given branch is not affected by discharge from nozzles in other branches; only nozzles located in the same branch affect each other.

As will be seen from FIG. 8, a nozzle does not affect another nozzle located four nozzles away therefrom. For example, the nozzle B and the nozzle F can be operated simultaneously without affecting the discharge amount of each other.

The rate of change of the discharge amount illustrated in FIG. 8 is caused by the cross-talk effects between nozzles that vary between the nozzles located centrally of the branch 162A, which have other nozzles on both sides, and the nozzles at the ends of the branch 162A, each of which has other nozzles only on one side.

The numbers given on the horizontal axis of the graph in FIG. 8 represent relative positions of the nozzles operated simultaneously: positive numbers represent intervals between nozzles located on the side where the reference characters of the nozzles progress in alphabetical order as they are further distanced from a nozzle of interest; “1” in FIG. 8, for example, represents the nozzle C and the nozzle D. Negative numbers represent intervals between nozzles located on the side where the reference characters of the nozzles progress in reversed alphabetical order as they are further distanced from a nozzle of interest; “−1” in FIG. 8, for example, represents the nozzle D and the nozzle C.

FIG. 9 is a graph illustrating the rate of change of discharge amount of the nozzles A to F when the adjacent nozzles on both sides (one nozzle one each side) of a nozzle of interest are operated simultaneously.

The nozzles A and F each have other nozzles (nozzle B or E) on one side thereof only. Accordingly, the nozzles A and F are affected by other nozzles located only on one side thereof so that the rate of change of discharge amount is small as illustrated in FIG. 9. By contrast, the nozzles B to E each have other nozzles on both sides thereof in the same branch 162A and thus receive cross-talk effects from these other nozzles on both sides. Therefore, when adjacent nozzles on both sides are operated simultaneously (one nozzle on each side), a given nozzle receives cross-talk effects in such an amount as nozzles A and F<nozzles B to E.

FIG. 10 is a graph illustrating the rate of change of discharge amount of the nozzles A to F when the nozzles in proximity on both sides (two nozzles on each side) are operated simultaneously.

As described above, the nozzles A and F are each only affected by a nozzle on one side thereof (nozzle B or nozzle E) so that the rate of change of discharge amount is small as illustrated in FIG. 10.

On the other hand, the nozzles B and E each have one nozzle on one side thereof and two nozzles on the other side thereof that are operated simultaneously because of their locations, and receive cross-talk effects from these nozzles. The nozzles C and D have two nozzles each on both sides thereof and, thus, receive cross-talk effects from these nozzles. Therefore, when adjacent nozzles on both sides are operated simultaneously (one nozzle on each side), the nozzles receive cross-talk effects in such an amount as nozzles A and F<nozzles B and E<nozzles C and D.

According to the ink jet type recording, which uses halftone dot pattern as in error diffusion technique for tone reproduction, ink drops are released with substantially the same probability, though adjacent nozzles do not always discharge ink simultaneously, within an image having a substantially consistent density where inconsistent density tends to stand out. Thus, density variation as illustrated in FIG. 10 will be observed when seen macroscopically.

As illustrated in FIGS. 8 to 10, the central nozzles C and D in the same branch 162A are greatly affected by the nozzles close thereto so that the nozzles C and D are subject to a reduced discharge amount with a higher probability as compared with the nozzles A and F located at the ends of the branch. As illustrated in FIG. 11A, therefore, the ink drops discharged from the nozzles A to F form dots on the recording medium such that dots Ad and Fd made by the nozzles A and F are the largest, followed by dots Bd and Ed made by the nozzles B and E, dots Cd and Dd made by the nozzles C and D being the smallest.

This results in inconsistent density attributable to the cycle period of the row of nozzles connected to a given branch as illustrated in FIG. 11B. A scan made in the main scan direction R results in an inconsistent density having a period of the width of the row of the nozzles as projected onto a plane normal to the main scan direction R, i.e., inconsistent density in the auxiliary scan direction M.

Thus, according to JP 2005-313622 A, the dots Cd and Dd located close to the center of the branch 162A are small and the dots Ad and Fd at the ends of the branch 162A are large, resulting in the occurrence of inconsistent density in the auxiliary scan direction M attributable to a period of the ink jet head that returns to repeat its motion.

An object of the invention is to provide an image recording device and an image recording method capable of eliminating the problems associated with the prior art and reducing the occurrence of inconsistent density attributable to inconsistent ink discharge characteristics.

An image recording device according to the invention comprises: a transport unit for transporting a recording medium in an auxiliary scan direction; a recording head for drawing an image on the recording medium; a scanning unit for causing the recording head to scan the recording medium in a main scan direction that is normal to the auxiliary scan direction; and a control unit for controlling the transport unit, the recording head and the scanning unit to form an image in a same area of the recording medium extending in the main scan direction by shingling, wherein the recording head comprises blocks of nozzles arranged along the auxiliary scan direction for discharging ink drops to form dots that represent the image, each of the blocks of nozzles including nozzles being arranged at an angle to the main scan direction, the nozzles that form the dots representing the image formed by shingling in the same area of the recording medium extending in the main scan direction being composed of nozzles having different discharge characteristics within each of the blocks of nozzles.

An image recording method according to the invention comprises the steps of: transporting a recording medium in an auxiliary scan direction; and causing a recording head to scan a recording medium in a main scan direction that is normal to the auxiliary scan direction to form an image in a same area of the recording medium extending in the main scan direction by shingling, wherein the recording head comprises blocks of nozzles arranged along the auxiliary scan direction for discharging ink drops to form dots that represent the image, each of the blocks of nozzles including nozzles being arranged at an angle to the main scan direction, the nozzles that form the dots representing the image formed by shingling in the same area of the recording medium extending in the main scan direction being composed of nozzles having different discharge characteristics within each of the blocks of nozzles.

### BRIEF DESCRIPTION OF THE DRAWINGS

FIG. 1 is a schematic view illustrating an image recording device according to an embodiment of the invention.

FIG. 2 is a schematic plan view illustrating major peripherals of the recording head unit of the image recording device according to the embodiment.

FIG. 3A is a schematic view illustrating a recording head of the image recording device according to the embodiment of the invention; FIG. 3B is a schematic cross-section of the structure of a discharge unit of the recording head.

FIG. 4 is a block diagram illustrating major components of a system configuration of a control unit of the image recording device according to the embodiment of the invention.

FIG. 5 is a schematic view for explaining the image recording method using the image recording device according to the embodiment of the invention.

FIGS. 6A and 6B are schematic views illustrating the image recording method according to the embodiment in sequence.

FIG. 7 is a schematic view illustrating the recording head described in JP 2005-313622 A.

FIG. 8 is a graph illustrating the relative positions of nozzles operated simultaneously and the rate of change of discharge amount thereof, the vertical axis indicating the rate of change of discharge amount, the horizontal axis indicating numerals representing the relative positions of nozzles operated simultaneously.

FIG. 9 is a graph illustrating the rate of change of discharge amount when the adjacent nozzles on both sides (one nozzle on each side) are operated simultaneously, the vertical axis indicating the rate of change of discharge amount, the horizontal axis indicating the positions of nozzles operated simultaneously.

FIG. 10 is a graph illustrating the rate of change of discharge amount when the adjacent nozzles on both sides (two nozzles on each side) are operated simultaneously, the vertical axis indicating the rate of change of discharge amount, the horizontal axis indicating the positions of nozzles operated simultaneously.

FIG. 11A is a schematic view for explaining the dots formed using the recording head described in JP 2005-313622 A; FIG. 11B is a schematic view for explaining inconsistent density of an image formed using the recording head described in JP 2005-313622 A.

### DESCRIPTION OF THE PREFERRED EMBODIMENTS

Now, the image recording device and the image recording method according to the invention will be described referring to the preferred embodiment illustrated by the accompanying drawings in which:

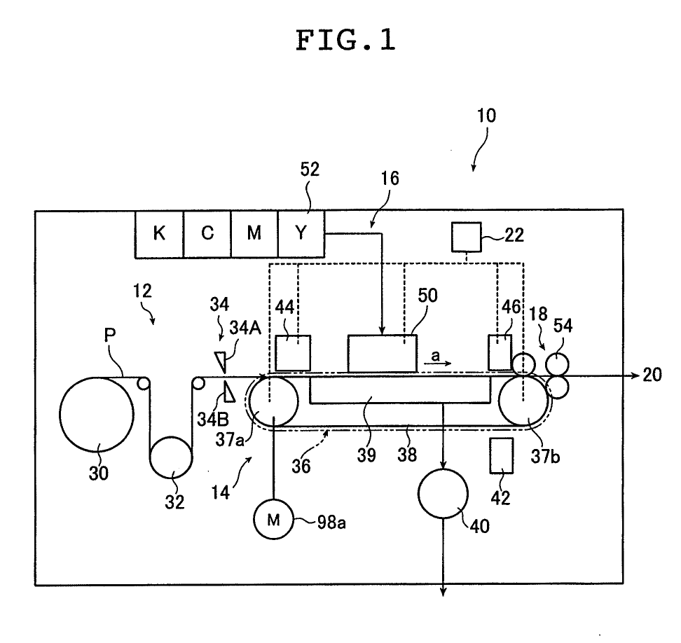

FIG. 1 is a schematic view illustrating an image recording device according to an embodiment of the invention.

An image recording device 10 basically comprises a feed assembly 12 for feeding a recording medium P, a transport assembly 14 for transporting the recording medium P fed from the feed assembly 12 with the recording medium P kept flat, a drawing assembly 16 including a recording head unit 50 disposed opposite the transport assembly 14 to draw an image on the recording medium P and an ink reservoir/filler unit 52 for storing ink fed to the recording head unit 50, a heating/pressing assembly 18 for heating and pressing the recording medium P on which an image has been drawn, an ejection assembly 20 for ejecting to the outside the recording medium P bearing the image, and a control unit 22 for controlling the above assemblies. The image recording device 10 is an inkjet type recording device.

The feed assembly 12 comprises a magazine 30, a heating drum 32, and a cutter 34.

The magazine 30 contains a roll of the recording medium P. When an image is drawn, the recording medium P is fed from the magazine 30 to the heating drum 32.

The heating drum 32 is disposed downstream of the magazine 30 on the transport path of the recording medium P to heat the recording medium P fed from the magazine 30, with the recording medium P bent reversely to the direction in which it was stored in the magazine 30.

The heating drum 32 heats the recording medium P to remove the shape the recording medium P assumed when it was stored in the magazine 30. That is, the heating drum 32 decurls the recording medium P. Preferably, the heating temperature is controlled so that the printing surface slightly curls outwards.

The cutter 34 comprises a fixed blade 34A having a length greater than the width of the transport path of the recording medium P and a round blade 34B that moves along the fixed blade 34A. The round blade 34B is disposed on the opposite side of the recording medium P from an image to be recorded; the fixed blade 34A is disposed on the opposite side of the transport path from the round blade 34B. The cutter 34 cuts the heating drum P fed through the heating drum 32 to a desired size.

In this embodiment, the feed assembly has one magazine. The invention is not limited to such a configuration, and two or more magazines may be provided to house recording media that are different in, for example, paper width, paper quality, and kind. In addition to or in place of the magazine, a cassette may be provided containing a number of cut sheets cut to a predetermined length. When using only a recording medium P previously cut to a predetermined length as the recording medium P, the heating roller and the cutter described above need not necessarily be provided.

When using a plurality of magazines and/or cassettes with a configuration where two or more kinds of recording paper can be used, it is preferable that an information recording unit such as bar code and wireless tag where information including, for example, the kind of paper is recorded is attached to the magazines and/or cassettes so that a reader can read out information recorded in the information recording unit to allow automatic recognition of the kind of paper used and perform ink discharge control to achieve an appropriate ink discharge according to the kind of paper.

The transport assembly 14 comprises a suction belt transport unit 36, a suction chamber 39, a fan 40, a belt cleaner 42, and a heating fan 44. The transport assembly 14 conveys the recording medium P, which was decurled and cut to a desired length by the feed assembly 12, to a drawing position where the drawing assembly 16 to be described draws an image on the recording medium P.

The suction belt transport unit 36 is disposed downstream of the cutter 34 on the transport path of the recording medium P and comprises a roller 37a, a roller 37b, a belt 38, and a motor 98a.

The belt 38 is an endless belt having a width greater than that of the recording medium P and passed over the roller 37a and the roller 37b. The belt 38 has numerous suction pores (not shown) formed in its surface.

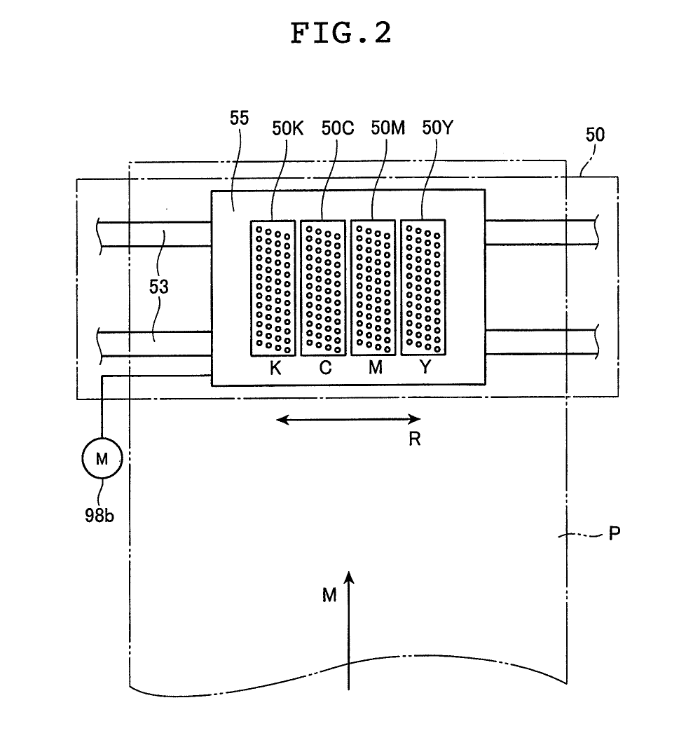

At least an image drawing (printing) area of the suction belt transport unit 36, i.e., the area thereof opposite the nozzle faces of the recording heads 50K to 50Y (see FIG. 2) of the recording head unit 50 be described of the drawing assembly 16, is kept flat with respect to the nozzle faces.

At least one of the rollers 37a and 37b over which the belt 38 is passed is connected to the motor 98a. Thus, the power generated by the motor 98a is transmitted to the belt 38 through at least one of the rollers 37a and 37b to drive the belt 38 clockwise as seen in FIG. 1 and transport the recording medium P held on the belt 38 in the direction “a” (rightwards in FIG. 1). The direction “a” is the same as the auxiliary scan direction M in which the recording medium P is transported by the motor 98a as an image is recorded. When the image is being recorded, the recording medium P is transported intermittently.

The means for transporting the recording medium P is not limited specifically; a roller nip transport mechanism may be used in place of the suction belt transport unit 36. Because the roller nip transport is liable to cause the image to feather as the roller touches the printing surface of the paper immediately after printing in the drawing region, the suction belt transport as in the embodiment under discussion is preferable whereby the image surface is not touched by the belt when passing through the drawing region.

The suction chamber 39 is provided on the inside of the belt 38 and opposite the nozzle faces of the recording heads 50K to 50Y (see FIG. 2) of the recording head unit 50 to be described of the drawing assembly 16. The fan 40 is connected to the suction chamber 39. The suction chamber 39 is sucked by the fan 40 to produce a negative pressure therein and hold the recording medium P onto the belt 38 by suction. The recording medium P, sucked onto the belt 38, can be held firmly.

The belt cleaner 42 is disposed on the outside of the belt 38 so as to face the outer surface of the annular belt 38 and located off the transport path of the recording medium P. Accordingly, the belt 38 passes through the drawing assembly 16, discharges the recording medium P to pressure rollers 54 to be described and then passes by a position opposite the belt cleaner 42.

The belt cleaner 42 removes ink that has stuck to the belt 38 after printing, for example, borderless photographs. The belt cleaner 42 may be configured by employing, for example, a method using a roller nip assembly using brush rolls or water-absorbing rolls, an air-blowing method whereby clean air is blown, or a method combining those methods. When a method using nipped cleaner rolls is employed, high cleaning effects are produced by giving the belt and rolls different linear velocities from each other.

The heating fan 44 is disposed on the outside of the belt 38 and upstream of the recording head unit 50 to be described of the drawing assembly 16 on the transport path of the recording medium P. The heating fan 44 blows hot air onto the recording medium P before drawing to heat the recording medium P. Heating the recording medium P before drawing makes it easier for ink to dry after landing thereon.

The drawing assembly 16 comprises the recording head unit 50 for recording (printing) an image and the ink reservoir/filler unit 52 for supplying ink to the recording head unit 50.

FIG. 2 is a schematic plan view illustrating major peripherals of the recording head unit of the image recording device according to the embodiment under discussion.

The recording head unit 50 comprises the recording heads 50K, 50C, 50M, and 50Y; their nozzle faces are located opposite the surface of the belt 38 on which the recording medium P is placed. The recording head unit 50 according to this embodiment further comprises a carriage 55 capable of reciprocating along two guide rails 53 extending in the direction of the width of the recording medium P (main scan direction R). The carriage 55 contains the recording heads 50K, 50C, 50M, and 50Y corresponding to inks of respective colors of black (K), cyan (C), magenta (M), and yellow (Y). The recording heads 50K, 50C, 50M, and 50Y are removably attached to the carriage 55. The carriage 55 is connected to a motor 98b that causes the carriage 55 to scan in the main scan direction R integrally with the recording heads 50K, 50C, 50M, and 50Y.

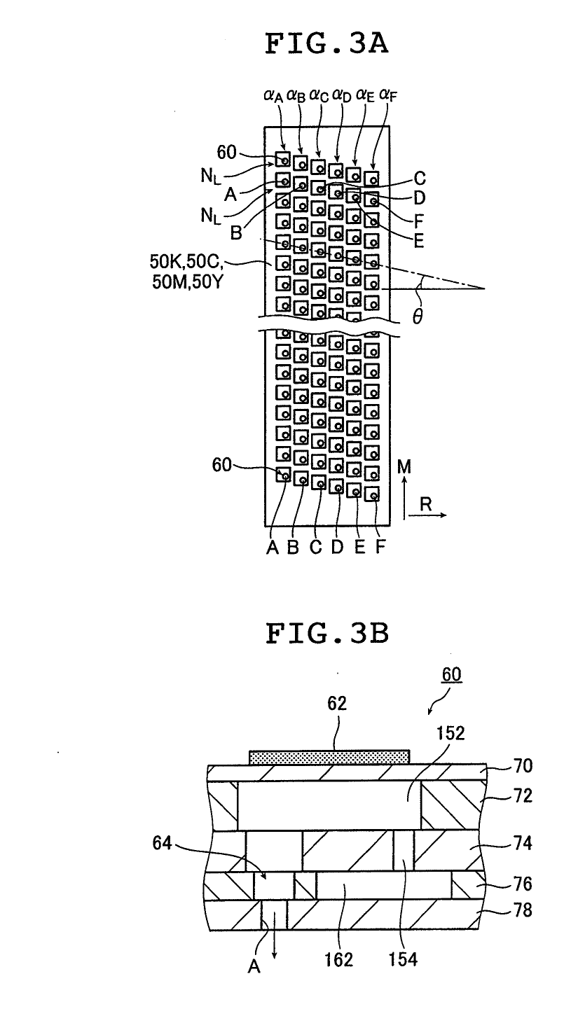

The recording heads 50K, 50C, 50M, and 50Y are ink jet heads that discharge inks each having the colors of black (K), cyan (C), magenta (M), and yellow (Y) from discharge units 60 (see FIG. 3A).

This embodiment uses the standard color combination of KCMY (four colors) but the invention permits the use of other ink color combinations and other numbers of colors so that light and dark color inks may be additionally used where necessary. For example, recording heads to discharge light color ink drops having colors such as light cyan, light magenta, and the like may be added.

Alternatively, one may use a recording head unit that has only a recording head for discharging ink drops representing the color of black (K), i.e., a monochromatic recording head to provide an image recording device for drawing monochromatic images.

The ink reservoir/filler unit 52 comprises ink supply tanks for storing inks each having colors corresponding to the recording heads 50K, 50C, 50M, and SOY, respectively. Each ink supply tank may, for example, be of a type whereby the tank is refilled with ink from an inlet (not shown) when the ink is running short or of a cartridge type whereby the whole tank is replaced.

The ink supply tanks of the ink reservoir/filler unit 52 are connected through conduit lines, not shown, to the recording heads 50K, 50C, 50M, and 50Y, respectively, to supply the recording heads 50K, 50C, 50M, and 50Y with inks.

Preferably, the ink reservoir/filler unit 52 comprises alarm means (display means, alarm sounding means, etc.) that, when ink is running short, gives a notification to that effect and a mechanism for preventing refill with ink of a wrong color.

When different kinds of ink are employed according to use, the cartridge type is preferably used. Preferably, a bar code or the like is used to identify the kind of ink and thus achieve a discharge control that is specific to the kind of ink.

The heating/pressing assembly 18 comprises a post-drying unit 46 and a pair of pressure rollers 54 to heat/press the recording medium P bearing an image drawn by the drawing assembly 16 and dry the image to fix it.

The post-drying unit 46 is disposed downstream of the recording head unit 50 and opposite the belt 38 on the transport path of the recording medium P. The post-drying unit 46 is a heating fan or the like for blowing hot air onto the image bearing side of the recording medium P to dry the image that has been drawn.

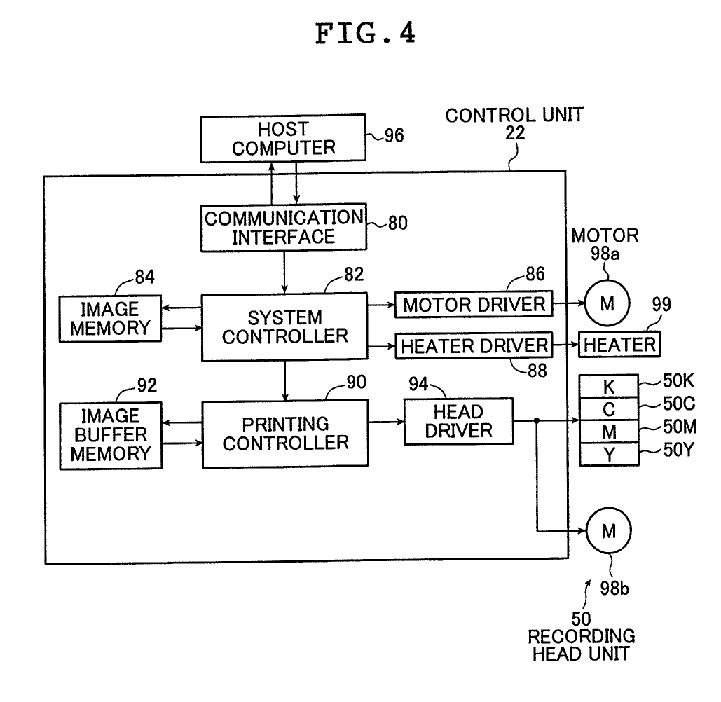

Preferably, the post-drying unit 46 uses a heating fan provided with a heater 99 (see FIG. 4) to blow hot air. Drying the ink of the image on the recording medium using the heating fan enables drying without touching the image. This prevents occurrence of defects or smears in the image drawn on the recording medium P.

The pair of pressure rollers 54 are disposed downstream of the post-drying unit 46 on the transport path of the recording medium P. The pair of pressure rollers 54 nip and transport the recording medium P that passed the post-drying unit 46 and parted from the belt 38.

The pair of pressure rollers 54 controls the glossiness of the image bearing surface. The image bearing surface of the recording medium P transported by the suction belt transport unit 36 is heated and pressed at the same time by the pressure rollers 54 having a surface provided with a given relief pattern to transfer the relief pattern onto the image bearing surface.

When dye-based ink is used for printing on porous paper, for example, applying pressure causes the pores of the paper to close, which prevents contact with substances such as ozone that can be a cause to destroy the dye molecules and thus provides the image with an enhanced weather resistance.

The ejection assembly 20 ejects the recording medium P bearing the image that has been fixed by the heating/pressing assembly 18. Preferably, the ejection assembly 20 comprises a sorter for collecting images according to orders placed. The number of ejection assemblies is not limited to one as in this embodiment. It is preferable to allow selection of an ejection assembly according to use. For example, two or more ejection assemblies may be provided.

The control unit 22 controls transport and heating of the recording medium P, drawing of an image thereon, and other operations performed by the feed assembly 12, the transport assembly 14, the drawing assembly 16, the heating/pressing assembly 18, and the ejection assembly 20. The configuration of the control unit 22 will be described later in detail.

Now, the structures of the recording heads 50K, 50C, 50M, and 50Y will be described. Since the recording heads 50K, 50C, 50M, and 50Y share the same configuration except for the color of the discharged ink, the recording head 50K will be described below as a representative. Since the nozzles A to F also share the same configuration, the nozzle A will be described as a representative.

FIG. 3A is a schematic view illustrating a recording head of the image recording device according to the embodiment of the invention; FIG. 3B is a schematic cross-section of the structure of a discharge unit of the recording head.

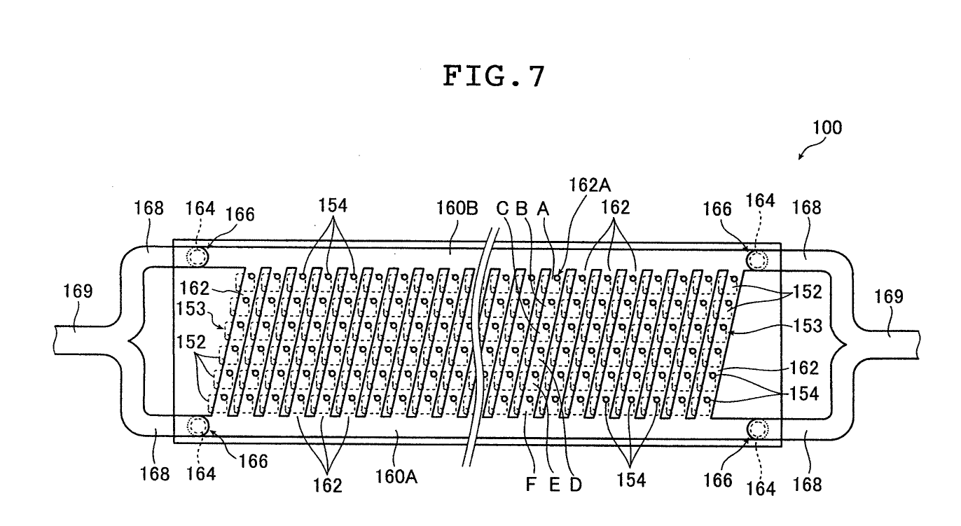

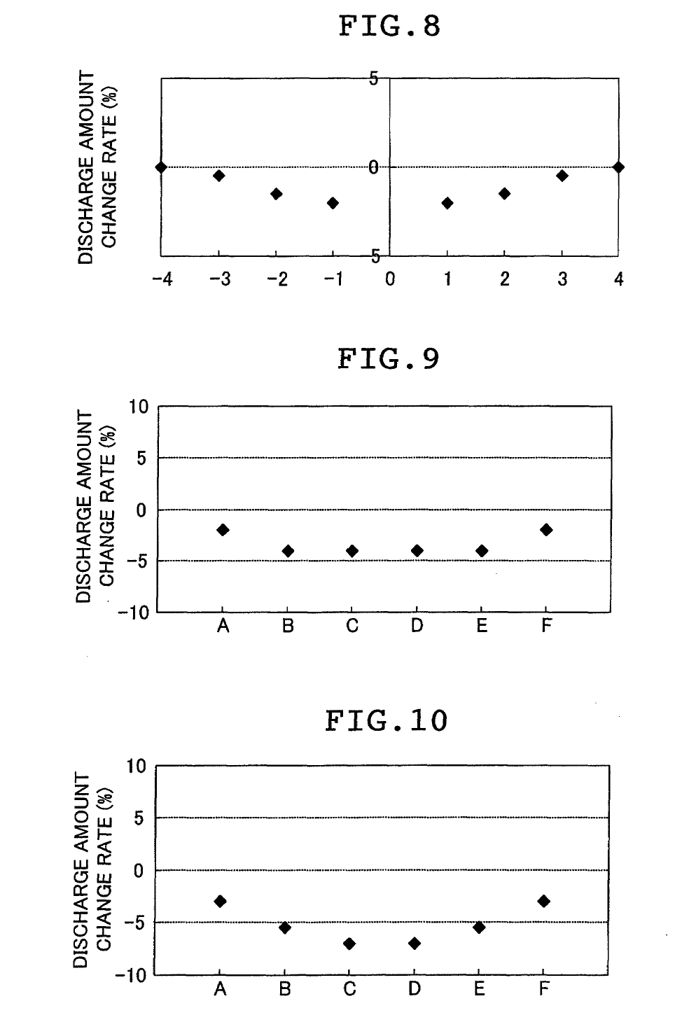

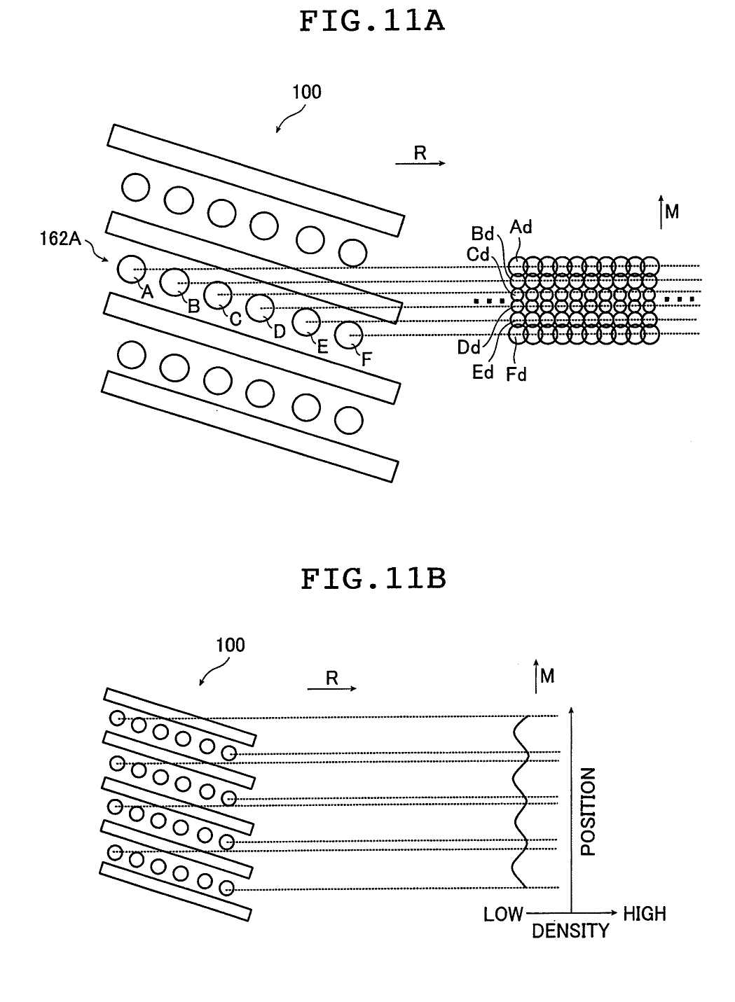

The discharge units 60 illustrated in FIG. 3B share the same configuration as the counterparts of the recording head 100 described in JP 2005-313622 A and illustrated herein in FIG. 7. Accordingly, like components are indicated by like characters, and detailed description thereof will not be given.

To increase the dot density with which the recording head 50K forms an image on the recording medium P, the density of the nozzles of the recording head 50K needs to be increased as illustrated in FIG. 3A.

The recording head 50K according to this embodiment has a plurality of nozzles (nozzles A to F), which discharge ink drops for forming dots to represent an image, arranged at a given angle θ to the main scan direction R. The nozzles A to F form rows of nozzles (blocks of nozzles). The rows of nozzles are disposed along the auxiliary scan direction M so as to provide a given resolution and arranged in a staggered fashion and in the form of a matrix.

In the recording head 50K according to this embodiment, each of the nozzles A to F that discharge ink drops is provided with the discharge unit 60. The discharge units 60 are disposed in a staggered fashion and in the form of a matrix. This arrangement of the nozzles A to F, i.e., the discharge units 60, allows an increased apparent density of the nozzles to be achieved.

In the recording head 50K, the nozzles A to F (discharge units 60) are arranged at a given angle θ to the main scan direction R. When a plurality of discharge units 60 are thus arranged at a given angle θ to the main scan direction R at a given pitch d, a pitch P of the nozzles as projected along the main scan direction R may be expressed as d×cos θ.

The nozzles A to F in the main scan direction R may be treated equivalently to the nozzles A to F as arranged linearly with the given pitch P. Such an arrangement allows a nozzle configuration to be achieved wherein a row of nozzles projected so as to be arranged in the main scan direction R provide a recording resolution (dot pitch) with a density as high as, for example, 1200 nozzles per inch.

As illustrated in FIG. 3A, six lines of nozzles α_{A} to α_{F}, for example, are arranged in the main scan direction R on the recording head 50K according to this embodiment. Each row of the nozzles N_{L} of the six lines is composed of six nozzles A to F. One branch 162 is provided for every row of nozzles N_{L} and the flow channels in each row of nozzles N_{L} are isolated from each other. Thus, one row of nozzles N_{L} is provided for one branch 162. This is also referred to herein as a nozzle block.

As illustrated in FIG. 3A, a number of nozzles A to F are provided in the recording head 50K in a staggered fashion, achieving a recording resolution (dot pitch) with a nozzle density as high as, for example, 1200 nozzles per inch in the auxiliary scan direction M.

Next, the inner structure of each discharge unit 60 of the recording head 50K will be described.

A pressure chamber 152 is provided for each nozzle A. The pressure chamber 152 is substantially a square as seen in top plan view where the nozzle A and a supply inlet 154 are located diagonally at the opposite corners. Each pressure chamber 152 communicates with the supply inlet 154 through the branch 162 (see FIG. 7). The pressure chamber 152 may have any shape as appropriate including a polygon such as a rectangle, a pentagon, or a hexagon, and an ellipse without any specific restrictions.

Each discharge unit 60 of the recording head 50 has, for example, a layered structure comprising a vibrating plate 70 and plates 72, 74, and 76 as illustrated in FIG. 3B.

The vibrating plate 70 according to this embodiment is made of a conductive material that is electrically connected with an electrode provided on the underside of a piezoelectric element 62 and acts also as a common electrode. The piezoelectric element 62 acts as an actuator.

The plate 72 has the pressure chamber 152 formed therein. The plate 74 has the supply inlet 154 through which ink is supplied to the pressure chamber 152 through the branch 162 formed in the plate 76. The branch 162 formed in the plate 76 communicates with common flow channels 160 A and 160B as described above (see FIG. 7). On the underside of the plate 76 is provided a nozzle plate 78 where the nozzle A is formed. An opening 64 is provided in the plates 74 and 76 to connect the nozzle A and the pressure chamber 152 for ink discharge.

A flexible wiring board (not shown) is provided on the upper side of the piezoelectric element 62 to receive a drive signal for driving and controlling the piezoelectric element 62. When the drive signal is applied to the piezoelectric element 62, the nozzle A discharges an ink drop.

The ink supply system comprising the common flow channels 160A, 160B, the branches 162, and main supply inlets 164 is endless. That is, there is no closed end throughout any of these flow paths. Specifically, the branches 162 are so provided as to bridge the upper and lower rows of common flow channels 160A, 160B and thus have no closed end. This configuration prevents stagnation of ink and allows ink to flow smoothly without stagnation.

Note that when the common flow channels 160A, 160B and the branches 162 are widened in a direction parallel to the nozzle faces of the nozzle plate 78, the ink flow rate per unit time can be increased but the recording head 50K grows larger in the main scan direction, lowering the array density of the nozzles A to F. To avoid this disadvantage, therefore, the common flow channels 160A, 160B and the branches 162 are preferably widened in a direction normal to the nozzle faces of the nozzle plate 78.

Next, the method whereby the discharge units 60 discharge ink will be described.

Ink is fed from each branch 162 to its supply inlet 154 and through the pressure chamber 152 to the nozzle A. When the drive signal (drive voltage) is applied to the piezoelectric element 62, with the pressure chamber 152 and the nozzle A both filled with ink, the vibrating plate 70 deforms to curve outwardly toward the nozzle A and thus pressurizes the pressure chamber 152, causing the nozzle A to discharge ink. Thus, activating the piezoelectric element 62 causes the nozzle A to discharge an ink drop.

Upon discharge of an ink drop from the nozzle A, fresh ink is fed to the pressure chamber 152 through the branch 162 and the supply inlet 154.

The configuration of the discharge unit is not limited specifically in this embodiment.

Although this embodiment uses deformation of an actuator as exemplified by a piezoelectric element to discharge ink drops, the invention is not limited to this method. The method of discharging ink drops is not limited specifically; in place of the method using a piezoelectric element, one may use a thermal jet method whereby ink is dried by heating with a heat generator such as a heater to produce air bubbles, which in turn generate a pressure that causes ink drops to be released.

FIG. 4 is a block diagram illustrating major components of a system configuration of the control unit 22 of the image recording device 10. The control unit 22 comprises a communication interface 80, a system controller 82, an image memory 84, a motor driver 86, a heater driver 88, a printing controller 90, an image buffer memory 92, and a head driver 94. As described earlier, the control unit 22 controls transport and heating of the recording medium P, drawing of an image thereon, and other operations performed by the feed assembly 12, the transport assembly 14, the drawing assembly 16, the heating/pressing assembly 18, and the ejection assembly 20.

The system controller 82 controls the communication interface 80, the image memory 84, the motor driver 86, the heater driver 88, among others. The system controller 82 comprises a central processing unit (CPU) and its peripheral circuits and controls communications with a host computer 96 and the read and write in the image memory 84 and some other operations. The system controller 82 generates a control signal for controlling the motor 98 in the transport system and the heater 99.

The communication interface 80 receives the image data from the host computer 96 and sends it to the system controller 82. The communication interface 80 may be a serial interface such as USB, IEEE1394, Ethernet (trademark), and a wireless network or a parallel interface such as Centronics. Further, a buffer memory may be mounted to increase communication speed.

The image memory 84 is memory means for temporarily storing an image entered through the communication interface 80 and allows data read/write through the system controller 82. The image memory 84 need not necessarily be a memory composed of a semiconductor device; it may be a magnetic medium such as a hard disk.

Communications data sent from the host computer 96 is loaded on the image recording device 10 through the communication interface 80 and stored in the image memory 84 through the system controller 82.

The motor driver 86 is a driver (drive circuit) for actuating the motor 98 according to the instructions given by the system controller 82.

The heater driver 88 is a driver (drive circuit) for actuating the heater 99 provided in the post-drying unit 46 according to the instructions given by the system controller 82.

The printing controller 90 has a signal processing function whereby processing such as reprocessing and correction is made to generate a printing control signal from image data in the image memory 84 according to the control by the system controller 82. The printing controller 90 supplies the printing control signal (printing data) it generates to the head driver 94. The printing controller 90 performs required signal processing and controls the ink drop discharge amounts for the recording heads 50K, 50C, 50M, and 50Y, the discharge timing, and the scan of the carriage 55 actuated by the motor 98b in the main scan direction R, i.e., the scan of the recording heads 50K, 50C, 50M, and 50Y in the main scan direction R based on the image data. Thus, a dot arrangement corresponding to an image to be recorded is achieved to form a linear image on the recording medium P. This process is repeated in the auxiliary scan direction to finally create the whole image.

The printing controller 90 has the image buffer memory 92 that temporarily stores data such as image data and parameters at the time of image data processing performed in the printing controller 90. While the image buffer memory 92 is illustrated in FIG. 4 as a subordinate unit to the printing controller 90, the image memory 84 may be adapted to serve also as the image buffer memory 92. Further, the printing controller 90 and the system controller 82 may be combined to provide a single processor performing the functions of both units.

The head driver 94 drives the piezoelectric elements 62 (actuators) of the discharge units 60 of the recording heads 50K, 50C, 50M, and 50Y each for different colors according to the image (printing) data supplied from the printing controller 90. The head driver 94 may include a feedback control system for keeping the head drive conditions constant.

Description will now be made as to how a print is produced by the image recording device 10. This embodiment uses shingling to form a desired image.

First, the recording medium P supplied from the magazine 30 of the feed assembly 12 is decurled and flattened by the heating drum 32. The recording medium P is then cut to a given length by the cutter 34 and fed to the transport assembly 14. The recording medium P fed to the transport assembly 14 is placed on the belt 38 of the suction belt transport unit 36 and transported as the belt 38 turns.

The recording medium P transported by the suction belt transport unit 36 is heated to a given temperature as it passes a position opposite the heating fan 44, and then passes a position opposite the recording head unit 50. At this time, the recording heads 50K, 50C, 50M, and 50Y are caused to scan the surface of the recording medium P by the motor 98b through the carriage 55 in the main scan direction R while the recording heads 50K, 50C, 50M, and 50Y in this order discharge ink drops to an area of the recording medium P extending with a given width in the main scan direction R. Upon completion of one scan, the recording medium P is moved a given pitch in the auxiliary scan direction M, say by half of the length of the recording heads 50K, 50C, 50M, and 50Y as measured in the auxiliary scan direction M. Then, as the recording heads are caused to scan in the main scan direction R by the motor 98b, inks are discharged again in the order of K, C, M, and Y onto the same area (including substantially the same area) of the recording medium P extending in the main scan direction R, to which area ink drops were discharged in the first main scan. Thus, a part of the image to be recorded is formed. The above procedure is repeated successively to form an image along the main scan direction R as the recording medium P is moved intermittently in the auxiliary scan direction M by a length for which recording is to be made by the recording heads in the auxiliary scan direction M until a complete image is formed on the recording medium P.

The recording medium P is sucked by the suction chamber 39 as the recording medium P passes a position opposite the recording head unit 50 so that the distance between the recording medium P and the recording head unit 50 is kept constant. The recording medium P having an image recorded thereon by the recording head unit 50 is transported further on by the belt 38, passes a position opposite the post-drying unit 46 so that the image formed by the inks is dried, and is pressed by pressure rollers 54 for fixation before being ejected from the ejection assembly 20.

This is how the image recording device 10 draws (records) an image on the recording medium P and produces a print.

When the recording head unit 50 according to this embodiment forms an image, shingling is accomplished in such a manner that the recording heads 50K, 50C, 50M, and 50Y are caused to scan the same area of the recording medium P extending in the main scan direction R at least twice in the main scan direction R. During the main scan, the recording medium P is moved at least once in the auxiliary scan direction M to form a linear image in substantially the same area (an image in substantially the same area). This image forming procedure is repeated until a desired image is finally created on the recording medium P.

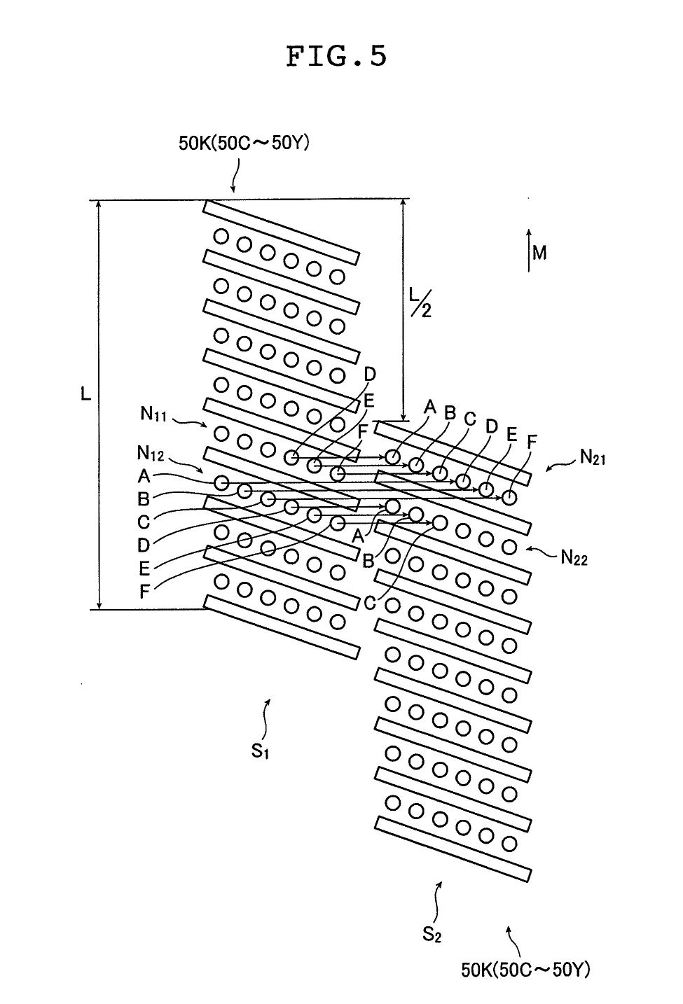

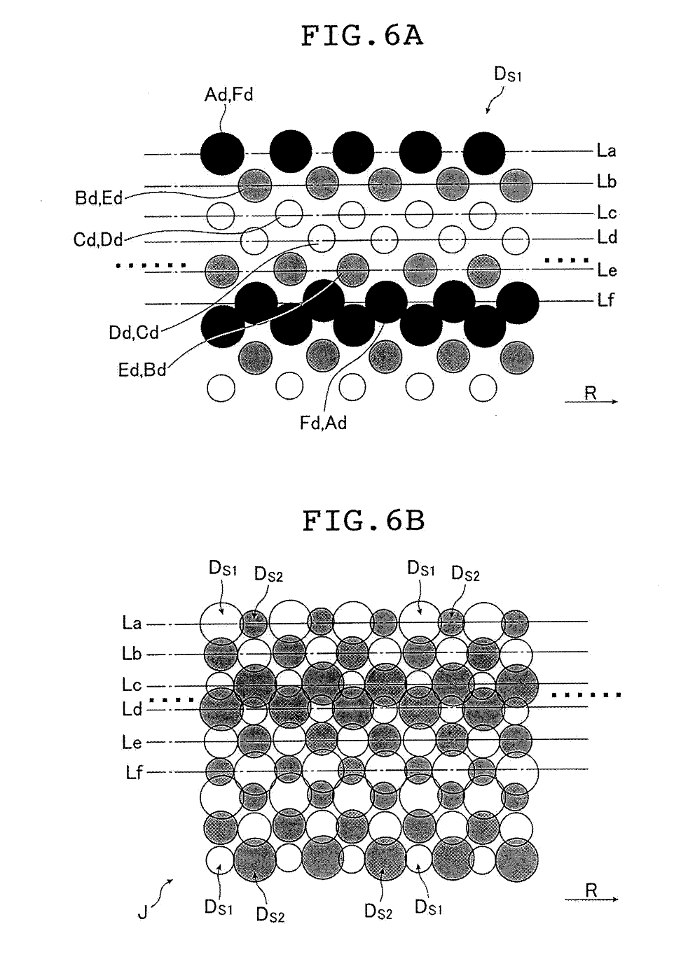

More specifically, in this embodiment, ink drops are discharged in a first scan S₁ (first pass) as illustrated in FIG. 5 according to an image recording signal that corresponds to an image to be formed in this scan in order to form dots constituting a part of the image as illustrated in FIG. 6A.

Thus, first dots D_{S1} are formed in the first pass as illustrated in FIG. 6A. In the first dots D_{S1}, a line La is formed by dots Ad, Fd made by the nozzles A, F; a line Lb is formed by dots Bd, Ed made by the nozzles B, E; a line Lc is formed by dots Cd, Dd made by the nozzles C, D; a line Ld is formed by dots Dd, Cd made by the nozzles D, C; a line Le is formed by dots Ed, Bd made by the nozzles E, B; and a line Lf is formed by dots Fd, Ad made by the nozzles F, A.

The lines La to Lf constitute an image in the area of the recording medium P extending in the main scan direction R and created by causing the recording heads 50K, 50C, 50M, and 50Y to scan in the main scan direction R.

Next, in the second main scan (second pass), ink drops are discharged according to the image recording signal, which corresponds to an image to be formed, to record a linear image J (see FIG. 6B) in an area of the recording medium P extending in the main scan direction R as the recording heads 50K to 50Y are moved in the main scan direction R after the recording medium P is moved relatively in the auxiliary scan direction M by a length L/2, as indicated by characters S₂ in FIG. 5, which is half of a length L of the recording heads 50K to 50Y as measured in the auxiliary scan direction M. A successive formation of such a linear image J in the auxiliary scan direction M allows a desired image to be recorded on the recording medium P.

In FIG. 6B, white circles represent the first dots D_{S1} formed in the first pass S₁; gray circles represent the second dots D_{S2} formed in the second pass S₁.

In this embodiment, the recording medium P is moved in the auxiliary scan direction M in such a manner as to meet the following conditions.

In this embodiment, the recording medium P is moved in the auxiliary scan direction M so that dots are formed in the second pass S₂ by the nozzles C, D located centrally of the branch 162 (row of nozzles N₂₁ in FIG. 5) on the same lines La, Lf formed in the first pass S₁ by the nozzles A, F located close to the ends of the branches 162 (rows of nozzles N₁₁, N₁₂ in FIG. 5); that dots are formed in the second pass S₂ by the nozzles F, A located close to the ends of the branches 162 (rows of nozzles N₂₁, N₂₂ in FIG. 5) on the lines Lc, Ld formed in the first pass S₁ by the nozzles C, D located centrally of the branch 162 (row of nozzles N₁₂ in FIG. 5); and that dots are formed in the second pass S2 by the nozzles E, B (rows of nozzles N₂₁, N₂₂ in FIG. 5) on the lines Lb, Le formed in the first pass S₁ by the nozzles B, E (row of nozzles N₁₂ in FIG. 5).

Thus, dots are formed in the second pass S2 by the nozzles C, D located centrally of the branch on the lines formed in the first pass S1 by the nozzles A, F located close to the ends of the branch in the image J as illustrated in FIG. 6B. Thus, the lines La to Lf composing the image J have a consistent average density whereas stripes and inconsistent density attributable to inconsistent discharge characteristics among nozzles caused by cross talk are corrected. Thus, stripes and inconsistent density occurring in image formation can be reduced. The effects produced are particularly remarkable for solid images, where adjacent nozzles tend to be operated simultaneously with a higher probability.

In this embodiment, each part of the image is formed on the recording medium P by a given width, which varies with the recording head, in the area extending in the main scan direction R by shingling achieved by the main scan that is performed twice, i.e., in two passes. The invention is however not limited this way, and the shingling may be accomplished in 3 passes or more. The configuration for achieving this is not limited specifically, the requirements thereof being that the ink drops released from the nozzles each located in their respective positions on the respective branches appear on the respective lines forming the image J with the same probability or that the dots from the nozzles located close to the ends appear with the same probability as those located close to the center.

While the image recording device and the image recording method according to the invention have been described in detail, the above embodiments are only illustrative and not restrictive and various changes and modifications may be made without departing from the spirit of the invention.

What is claimed is:

1. An image recording device comprising:
a transport unit for transporting a recording medium in an auxiliary scan direction;
a recording head for drawing an image on the recording medium;
a scanning unit for causing the recording head to scan the recording medium in a main scan direction that is normal to the auxiliary scan direction; and
a control unit for controlling the transport unit, the recording head and the scanning unit to form an image in a same area of the recording medium extending in the main scan direction by shingling,
wherein the recording head comprises blocks of nozzles arranged along the auxiliary scan direction for discharging ink drops to form dots that represent the image, each of the blocks of nozzles including nozzles being arranged at an angle to the main scan direction, the nozzles that form the dots representing the image formed by shingling in the same area of the recording medium extending in the main scan direction being composed of nozzles having different discharge characteristics within each of the blocks of nozzles.

2. The image recording device according to claim 1, wherein nozzles of different blocks are connected to different ink supply flow channels, and nozzles in each of the blocks are connected to a same ink supply flow channel.

3. The image recording device according to claim 1, wherein the different discharge characteristics of the nozzles in each of the blocks of nozzles are due to cross talk.

4. The image recording device according to claim 2, wherein nozzles used to form an image in the same area extending in the main scan direction each have different positions in a flow channel of the block of nozzles.

5. The image recording device according to claim 4, wherein nozzles used to form an image in the same area extending in the main scan direction are composed of nozzles connected close to ends of the flow channel of the block of nozzles combined with nozzles connected close to a center of the flow channel with a same probability.

6. An image recording method comprising the steps of:
transporting a recording medium in an auxiliary scan direction; and
causing a recording head to scan a recording medium in a main scan direction that is normal to the auxiliary scan direction to form an image in a same area of the recording medium extending in the main scan direction by shingling,
wherein the recording head comprises blocks of nozzles arranged along the auxiliary scan direction for discharging ink drops to form dots that represent the image, each of the blocks of nozzles including nozzles being arranged at an angle to the main scan direction, the nozzles that form the dots representing the image formed by shingling in the same area of the recording medium extending in the main scan direction being composed of nozzles having different discharge characteristics within each of the blocks of nozzles.

7. The image recording method according to claim 6, wherein nozzles used to form an image in the same area extending in the main scan direction each have different positions in a flow channel of the block of nozzles.

8. The image recording method according to claim 6, wherein nozzles used to form an image in the same area extending in the main scan direction are composed of nozzles connected close to ends of the flow channel of the block of nozzles combined with nozzles connected close to a center of the flow channel with a same probability.
